(19) United States
(12) Patent Application Publication
(10) Pub. No.: US 2026/0038933 A1
(43) Pub. Date: Feb. 5, 2026

(54) WIRE SEALING APPARATUS, WATERPROOF BATTERY PACK, AND METHOD OF MANUFACTURING WATERPROOF BATTERY PACK

(71) Applicant: Samsung SDI Co., Ltd., Yongin-si (KR)

(72) Inventor: Sanghun Park, Yongin-si (KR)

(73) Assignee: Samsung SDI Co., Ltd., Yongin-si (KR)

(21) Appl. No.: 19/197,659

(22) Filed: May 2, 2025

(30) Foreign Application Priority Data
Jul. 31, 2024 (KR) 10-2024-0102166

(51) Int. Cl. H01M 50/24; H01M 50/209; H01M 50/213; H01M 50/502

(52) U.S. Cl. CPC H01M 50/24; H01M 50/209; H01M 50/213; H01M 50/502

(57) ABSTRACT

Disclosed are a wire sealing apparatus, a waterproof battery pack, and a method of manufacturing the waterproof battery pack. The wire sealing apparatus may be a wire sealing apparatus for surrounding a battery core pack with a waterproof material and sealing wires of the battery core pack, and may include a band part that extends in a length direction thereof, a plurality of elastic members provided at intervals of one or more elastic members in the length direction of the band part, and a clamping part configured to seat a plurality of wires interposed in a waterproof material in an interval between the plurality of elastic members and to clamp the band part so that the band part surrounds and seals the plurality of elastic members, the waterproof material, and the plurality of wires.

### CROSS-REFERENCE TO RELATED APPLICATIONS

This present application claims priority to and the benefit under 35 U.S.C. § 119(a)-(d) of Korean Patent Application No. 10-2024-0102166, filed on Jul. 31, 2024, in the Korean Intellectual Property Office, the entire disclosure of which is incorporated herein by reference.

### FIELD

The present disclosure relates to a wire sealing apparatus, a waterproof battery pack, and a method of manufacturing the waterproof battery pack.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery may include an electrode assembly consisting of a positive electrode and a negative electrode, a case that accommodates the electrode assembly, a terminal part connected to the electrode assembly, etc.

The above information disclosed in this Background section is for enhancement of understanding of the background of the present disclosure, and therefore, it may contain information that does not constitute related (or prior) art.

### SUMMARY

Some embodiments of the present disclosure provide a wire sealing apparatus, a waterproof battery pack, and a method of manufacturing the waterproof battery pack, for securing a waterproof condition for a battery pack.

However, the technical problem to be solved by the present disclosure is not limited to the problems described herein, and other problems not mentioned herein, and aspects and features of the present disclosure that would address such problems, will be clearly understood by those skilled in the art from the description of the present disclosure below.

A wire sealing apparatus according to embodiments of the present disclosure may be a wire sealing apparatus for surrounding a battery core pack with a waterproof material and sealing wires of the battery core pack, and may include a band part that extends in a length direction thereof, a plurality of elastic members provided at intervals of one or more elastic members in the length direction of the band part, and a clamping part configured to seat a plurality of wires interposed in a waterproof material in an interval between the plurality of elastic members and to clamp the band part so that the band part surrounds and seals the plurality of elastic members, the waterproof material, and the plurality of wires.

In embodiments, the size of the interval between the plurality of elastic members may correspond to the size of the seated wires.

In embodiments, the elastic member may be made of a material having a compression ratio of 50% to 90%.

In embodiments, the elastic member may be high-density polyurethane foam or rubber.

In embodiments, the elastic member may be selected from a material that satisfies an equation below, assuming that A_{T} is an area within the band part that surrounds and seals the plurality of elastic members, the waterproof material, and the plurality of wires, W_{T} is a sum of cross sections of the plurality of wires, E_{T} is a sum of areas of the plurality of elastic members on a wire side before sealing, and C is a compression ratio of the elastic member.

$${A}_{T} - {W}_{T} = {E}_{T} \times C$$

In embodiments, a plurality of trapping jaws may be formed on one surface of the band part.

In embodiments, a fixing jaw that is trapped between the plurality of trapping jaws may be formed in the clamping part.

A waterproof battery pack according to embodiments of the present disclosure may include a battery core pack, a waterproof material configured to surround the battery core pack, and a wire sealing apparatus for sealing a plurality of wires of the battery core pack. The wire sealing apparatus may include a band part that extends in a length direction thereof, a plurality of elastic members provided at intervals of one or more elastic members in the length direction of the band part, and a clamping part configured to seat the plurality of wires interposed in the waterproof material in an interval between the plurality of elastic members and to clamp the band part so that the band part surrounds and seals the plurality of elastic members, the waterproof material, and the plurality of wires.

In embodiments, the size of the interval between the plurality of elastic members may correspond to the size of the seated wires.

In embodiments, the elastic member may be made of a material having a compression ratio of 50% to 90%.

In embodiments, the elastic member may be high-density polyurethane foam or rubber.

In embodiments, the elastic member is selected from a material that satisfies an equation below, assuming that A_{T} is an area within the band part that surrounds and seals the plurality of elastic members, the waterproof material, and the plurality of wires, W_{T} is a sum of cross sections of the plurality of wires, E_{T} is a sum of areas of the plurality of elastic members on a wire side before sealing, and C is a compression ratio of the elastic member.

$${A}_{T} - {W}_{T} = {E}_{T} \times C$$

In embodiments, a plurality of trapping jaws may be formed on one surface of the band part.

In embodiments, a fixing jaw that is trapped between the plurality of trapping jaws may be formed in the clamping part.

A method of manufacturing a waterproof battery pack according to embodiments of the present disclosure may include providing a battery core pack, surrounding the battery core pack with a waterproof material, providing a wire sealing apparatus that is a wire sealing apparatus for sealing a plurality of wires of the battery core pack and that comprises a band part that extends in a length direction thereof, a plurality of elastic members that are provided at intervals of one or more elastic members in the length direction of the band part, and a clamping part that clamps the band part, and seating the plurality of wires interposed in the waterproof material in the interval between the plurality of elastic members and clamping the band part so that the band part surrounds and seals the plurality of elastic members, the waterproof material, and the plurality of wires.

In embodiments, the providing of the wire sealing apparatus may include forming the plurality of elastic members so that the size of the interval between the plurality of elastic members may correspond to the size of the seated wires.

In embodiments, the providing of the wire sealing apparatus may include forming the elastic member having a material having a compression ratio of 50% to 90%.

In embodiments, the providing of the wire sealing apparatus may include selecting the elastic member from a material that satisfies an equation below, assuming that A_{T} is an area within the band part that surrounds and seals the plurality of elastic members, the waterproof material, and the plurality of wires, W_{T} is a sum of cross sections of the plurality of wires, E_{T} is a sum of areas of the plurality of elastic members on a wire side before sealing, and C is a compression ratio of the elastic member.

$${A}_{T} - {W}_{T} = {E}_{T} \times C$$

In embodiments, the providing of the wire sealing apparatus may include forming a plurality of trapping jaws on one surface of the band part.

In embodiments, the providing of the wire sealing apparatus may further include forming, in the clamping part, a fixing jaw that is trapped between the plurality of trapping jaws.

According to embodiments of the present disclosure, the battery core pack can be sealed without using resin, such as bonds, because the plurality of wires may be sealed by the elastic members.

According to embodiments of the present disclosure, it is possible to secure strong sealing power of the waterproof battery pack because a curved surface of the wire is filled by soft properties of the elastic member and sealed through an external strong clamping force between the band part and the clamping part.

According to embodiments of the present disclosure, it is possible to seal the battery core pack through a simple structure because the elastic member may be integrated with an escape structure corresponding to a cross sectional shape of the wire.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings accompanying this specification illustrate exemplary embodiments of the present disclosure, and help to further understand the technical spirit of the present disclosure along with the aforementioned contents of the disclosure. Accordingly, the present disclosure should not be construed as being limited to only contents described in such drawings.

FIG. 1A is an upper perspective view of a cylindrical secondary battery.

FIG. 1B is a cross-sectional diagram of the cylindrical secondary battery.

FIG. 2A is an upper perspective view of a prismatic secondary battery.

FIG. 2B is a cross-sectional view taken along line I-I′ in FIG. 2A.

FIG. 3 is a diagram for describing a method of manufacturing a conventional waterproof battery pack.

FIG. 4A is a perspective view of a wire sealing structure for a conventional waterproof battery pack.

FIG. 4B is a cross-sectional diagram of the wire sealing structure for a conventional waterproof battery pack.

FIG. 5 is a perspective view of a wire sealing apparatus according to embodiments of the present disclosure.

FIG. 6 is a cross-sectional view illustrating a form in which a clamping part of the wire sealing apparatus, according to embodiments of the present disclosure, clamps a band part.

FIG. 7A is a perspective view illustrating a form in which a plurality of wires interposed in a waterproof material is seated in the wire sealing apparatus according to embodiments of the present disclosure.

FIG. 7B is a cross-sectional view illustrating a form in which the plurality of wires interposed in the waterproof material has been seated in the wire sealing apparatus according to embodiments of the present disclosure.

FIG. 8A is a perspective view illustrating a form in which the clamping part of the wire sealing apparatus according to embodiments of the present disclosure has been clamped.

FIG. 8B is a cross-sectional view illustrating a form in which the clamping part of the wire sealing apparatus according to embodiments of the present disclosure has been clamped.

FIG. 9 is a flowchart for describing a method of manufacturing the waterproof battery pack according to embodiments of the present disclosure.

### DETAILED DESCRIPTION

Exemplary embodiments of the present disclosure will be described below in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals may be designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course.

These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also it can be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure. The type of secondary battery includes a coin type, a cylindrical type, a prismatic type, and a pouch type. Prior to a description of embodiments of the present disclosure, first, cylindrical and prismatic secondary batteries are generally described because the present disclosure may be applied to the cylindrical and prismatic secondary batteries.

If a battery pack constructed by using a secondary battery is used in an environment that is prone to water penetration around, a waterproof condition for the battery pack is required. In this case, in order to secure the waterproof condition for the battery pack, a battery core pack is surrounded by a waterproof material such as vinyl, and a product is sealed through thermosetting or bonding using adhesives. However, in the structure in which the battery core pack is surrounded by the waterproof material as described above, if a wire for connecting the battery core pack to the outside is constructed, a portion corresponding to the wire needs to be sealed by using a separate method because it is difficult to seal the portion through only the waterproof material. Conventionally, the portion corresponding to the wire is sealed by resin, but there is a problem in that it is difficult to completely seal the portion.

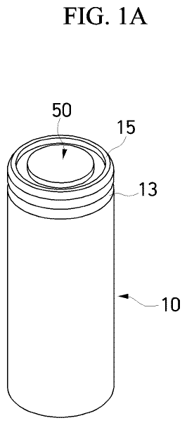

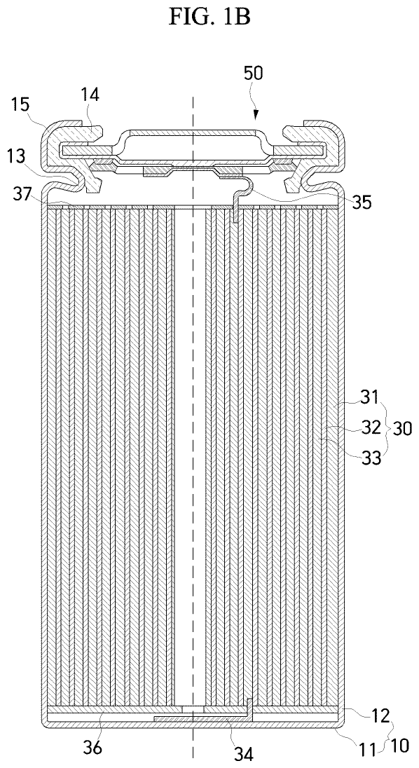

FIG. 1A is an upper perspective view of a cylindrical secondary battery. FIG. 1B is a cross-sectional view of the cylindrical secondary battery.

Referring to FIG. 1A and FIG. 1B, the cylindrical secondary battery may include an electrode assembly 30, a case 10 that accommodates the electrode assembly 30 and an electrolyte therein, a cap assembly 50 that is connected to an opening of the case 10 and that seals the case 10, and an insulating plate 37 disposed between the electrode assembly 30 and the cap assembly 50 within the case 10.

The electrode assembly 30 may include a separator 32 and a first electrode 33 and the second electrode 31 with the separator 32 interposed between, and may be wound in a jelly-roll form.

The first electrode 33 may include a first base and a first active material layer disposed in the first base. A first lead tap 35 may be extended from a first uncoated part that belongs to the first base and in which the first active material layer is not disposed to the outside. The first lead tap 35 may be electrically connected to the cap assembly 50.

The second electrode 31 may include a second base and a second active material layer disposed in the second base. A second lead tap 34 may be extended from a second uncoated part that belongs to the second base and in which the second active material layer is not disposed to the outside. The second lead tap 34 may be electrically connected to the case 10. The first lead tap 35 and the second lead tap 34 may be extended in opposite directions.

The first electrode 33 may function as a positive electrode. In this case, the first base may be composed of aluminum (Al) foil, for example. The first active material layer may include transition metal oxide, for example. The second electrode 31 may function as a negative electrode. In this case, the second base may be composed of copper foil or nickel foil, for example. The second active material layer may include graphite, for example.

The separator 32 may function to permit a movement of lithium ions and to prevent the short-circuit of the first electrode 33 and the second electrode 31. The separator 32 may be composed of a polyethylene film, a polypropylene film, or a polyethylene-polypropylene film, for example. The case 10 may accommodate the electrode assembly 30 and an electrolyte and form an external form of the battery along with the cap assembly 50.

The case 10 may include a body part 12 having an approximate cylindrical shape and a bottom part 11 connected to one side of the body part 12. A beading part 13 that has been deformed toward the inside of the body part 12 may be disposed in the body part 12. A crimping part 15 that has been bent toward the inside of the body part 12 may be disposed at an end of the body part 12 on the opening side.

The beading part 13 may suppress a movement of the electrode assembly 30 within the case 10, and may facilitate the settlement of a gasket 14 and the cap assembly 50. The crimping part 15 may firmly fix the cap assembly 50 by pressurizing an edge of the cap assembly 50 through the gasket 14. The case 10 may be made of iron plated with nickel, for example.

The cap assembly 50 may seal the case 10 by being fixed to the inside of the crimping part 15 through the gasket 14. The cap assembly 50 may include a cap-up part, a safety vent, a cap-down part, an insulating member, and a sub-plate, but the present disclosure is not limited to such examples. The cap assembly 50 may be variously deformed.

The cap-up part may be disposed at the top of the cap assembly 50. The cap-up part may include a terminal part that upward convexly protrudes and that is connected to an external circuit. An output for discharging a gas around the terminal part may be disposed in the cap-up part.

The safety vent may be disposed under the cap-up part. The safety vent may include a protruding part that convexly protrudes downward and that is connected to the sub-plate, and at least one notch disposed around the protruding part.

When a gas is generated due to over-charging or an abnormal operation of the secondary battery, the protruding part may be deformed upward by the pressure of the gas and separated from the sub-plate. Furthermore, the safety vent may be cut along the notch. The cut safety vent can prevent the explosion of the secondary battery by discharging the gas to the outside.

The cap-down part may be disposed under the safety vent. A first opening for exposing the protruding part of the safety vent and a second opening for discharging a gas may be disposed in the cap-down part. The insulating member may be disposed between the safety vent and the cap-down part, and may insulate the safety vent and the cap-down part.

The sub-plate may be disposed under the cap-down part. The sub-plate may be fixed to the bottom of the cap-down part in order to close the first opening of the cap-down part. The protruding part of the safety vent may be fixed to the sub-plate. The first lead tap 35 that has been withdrawn from the electrode assembly 30 may be fixed to the sub-plate. Accordingly, the cap-up part, the safety vent, the cap-down part, and the sub-plate may be electrically connected to the first electrode 33 of the electrode assembly 30.

The insulating plate 37 may be disposed to adjoin the electrode assembly 30 under the beading part 13. A tap opening for withdrawing the first lead tap 35 may be provided in the insulating plate 37. The cap assembly 50 that has been electrically connected to the first electrode 33 by the first lead tap 35 may face the electrode assembly 30 with the insulating plate 37 interposed therebetween.

The cap assembly 50 may maintain the state in which the cap assembly 50 has been insulated from the electrode assembly 30 by the insulating plate 37. The cylindrical secondary battery may include another insulating plate 36 for insulation between the electrode assembly 30 and the bottom part 11 of the case 10.

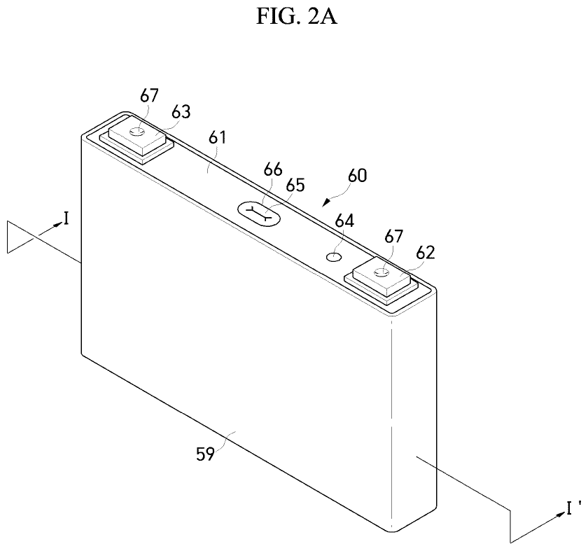

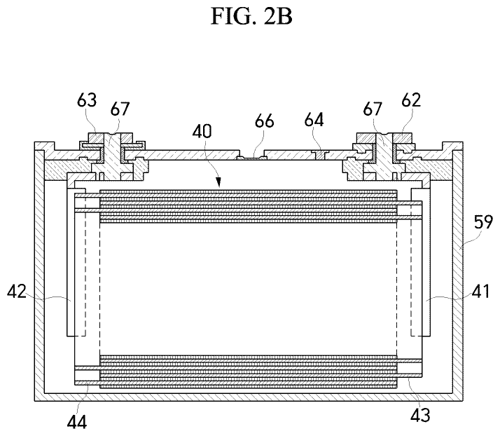

FIG. 2A is a top perspective view of a prismatic secondary battery. FIG. 2B is a cross-sectional view taken along the line I-I′ of FIG. 2A.

First, the external appearance of the prismatic secondary battery illustrated in FIG. 2A will be described.

A case 59 may define an overall appearance of the prismatic secondary battery, and may be made of a conductive metal, such as aluminum, aluminum alloy, or nickel-plated steel. In addition, the case 59 may provide a space for accommodating an electrode assembly therein.

A cap assembly 60 may include a cap plate 61 that covers the opening of the case 59. In some examples, the case 59 and the cap plate 61 may be made of a conductive material. Here, a first terminal 62 and a second terminal 63 may be electrically connected to respective positive and negative (or negative and positive) electrodes inside the case, and may be installed to protrude outward through the cap plate 61.

The cap plate 61 may be equipped with an electrolyte injection port 64 formed to install a sealing plug (or seal pin), and a vent 66 formed with a notch 65. The vent 66 may be included for discharging gas generated inside the secondary battery.

With reference to FIG. 2B, the internal structure of the prismatic secondary battery and the coupling structure with the cap assembly 60 will be further described.

As shown in FIG. 2B, a prismatic secondary battery may include an electrode assembly 40, a first current collector 41, a first terminal 62, a second current collector 42, a second terminal 63, a case 59, and a cap assembly 60.

An electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction (e.g., the y direction) of the case 59. In some other embodiments, the electrode assembly 40 is a stack type rather than a winding type, and the shape of the electrode assembly 40 is not limited in the present disclosure. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. Of course, the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 43 (e.g., a first uncoated portion) that is a region to which the first electrode active material is not applied. The first electrode tab 43 may act as a current flow path between the first electrode plate and the first current collector 41. In some embodiments, when the first electrode plate is manufactured, the first electrode tab 43 is formed by being cut in advance to protrude to one side of the electrode assembly 40, or the first electrode tab 43 protrudes to one side of the electrode assembly 40 more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 44 (e.g., a second uncoated portion) that is a region to which the second electrode active material is not applied. The second electrode tab 44 may act as a current flow path between the second electrode plate and the second current collector 42. In some embodiments, the second electrode tab 44 may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In some embodiments, the first electrode tab 43 is located on the left side of the electrode assembly 40, and the second electrode tab 44 may be located on the right side of the electrode assembly 40. In some other embodiments, the first electrode tab 43 and the second electrode tab 44 are located on one side of the electrode assembly 40 in the same direction. Here, for simplicity of description, the left and right sides are defined according to the secondary battery as oriented in FIG. 1, and the positions thereof may change when the secondary battery is rotated left and right or up and down.

The separator can prevent or substantially reduce instances of a short circuit between the first electrode and the second electrode while allowing movement of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate may be positioned at both ends (e.g., opposite ends) of the electrode assembly 40. In some embodiments, the electrode assembly 40 is accommodated in the case 59 along with an electrolyte.

In addition, in the electrode assembly 40, the first current collector 41 and the second current collector 42 may be welded and connected to the first electrode tab 43 of the first electrode plate and the second electrode tab 44 of the second electrode plate exposed on both sides, respectively, to then be positioned thereat, respectively.

The first current collection part 41 and the second current collection part 42 may be connected to the first terminal 62 and the second terminal 63 described with reference to FIG. 2A, through terminal pins 67, respectively. In some embodiments, outer circumference surfaces of the terminal pins 67 may be subjected to screw processing, and may be fastened to the first terminal 62 and the second terminal 63, respectively, through screw coupling. However, the present disclosure is not limited to such an example, and the terminal pins 67 may be connected to the first terminal 62 and the second terminal 63 in a riveting way or by welding.

The plurality of cylindrical secondary batteries or prismatic secondary batteries, which have been described by taking FIGS. 1A to 2B as examples, may be gathered and packaged to form a battery core pack. The battery core pack that is formed as described above may be sealed by a waterproof material along with wires through the wire sealing apparatus according to embodiments of the present disclosure, thus constituting a waterproof battery pack. A wire sealing apparatus according to embodiments of the present disclosure is described below with reference to drawings.

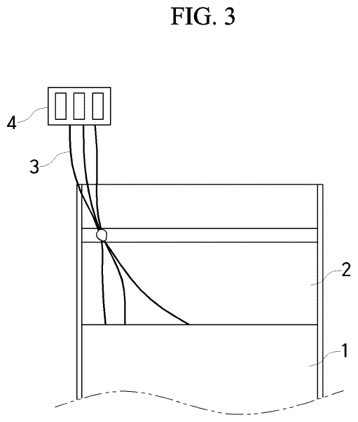

FIG. 3 is a diagram for describing a method of manufacturing a conventional waterproof battery pack.

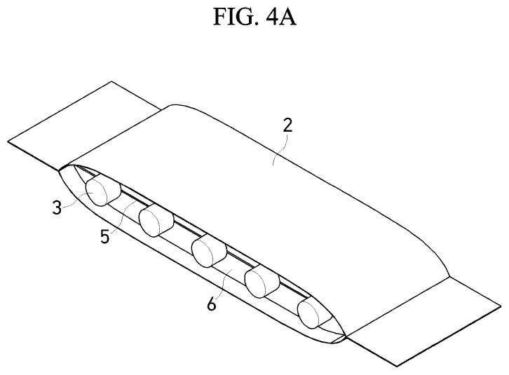

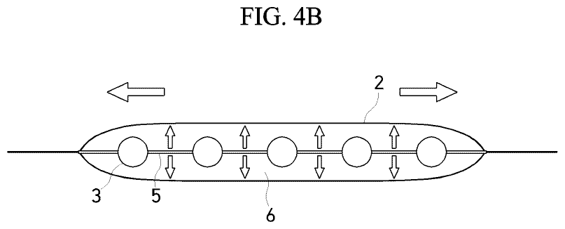

Referring to FIG. 3, the product of the conventional waterproof battery pack is sealed through thermosetting or bonding using adhesives by putting a battery core pack 1 into the waterproof battery pack and being surrounded with a waterproof material 2. In this case, wires 3 for connecting the battery core pack 1 to an external device 4 are sealed by filling thermosetting resin because it is difficult to seal the wires through only the waterproof material 2. A wire sealing structure for the conventional waterproof battery pack, which has been sealed by using such a method, is described with reference to FIGS. 4A and 4B.

FIG. 4A is a perspective view of a wire sealing structure for a conventional waterproof battery pack. FIG. 4B is a cross-sectional diagram of a wire sealing structure for a conventional waterproof battery pack.

Referring to FIGS. 4A and 4B, in the wire sealing structure for the conventional waterproof battery pack, a plurality of wires 3 is first fixed through a double-sided tape 5, a waterproof material 2 is filled with resin 6, and the resin 6 is subjected to thermosetting, so that the conventional waterproof battery pack is sealed. In such a structure, sealing is maintained, when the waterproof material 2 that constitutes the outskirts of the waterproof battery pack compresses the waterproof battery pack by a strong force thereof and the double-sided tape 5 at the central part of the waterproof battery pack withstands the strong force. However, as heat conducts from the center of the waterproof battery pack to both ends thereof in a process of hardening the resin 6, adhesive strength of the double-sided tape 5 may be weakened. Accordingly, there is a problem in that the sealing may not be maintained because the double-sided tape 5 is peeled off.

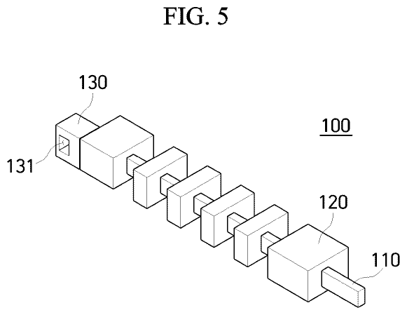

FIG. 5 is a perspective view of a wire sealing apparatus according to embodiments of the present disclosure.

Referring to FIG. 5, a wire sealing apparatus 100, according to embodiments of the present disclosure, may include a band part 110, a plurality of elastic members 120, and a clamping part 130.

The band part 110 may extend in a length direction thereof, may have a shape in which the band part has a small width and is thin, and may be bent well due to the nature of its material and shape. The band part 110 may be made of a synthetic resin material, and may serve to substantially surround a task target, such as several bundles of wires, by using its flexible properties.

The plurality of elastic members 120 may be provided at intervals of one or more elastic members in the length direction of the band part 110. An interval between the plurality of elastic members 120 is a space in which the wires 3 are seated. In embodiments, the size of the interval between the plurality of elastic members 120 may correspond to the size of the wires 3.

The clamping part 130 may seat the plurality of wires 3 interposed in the waterproof material 2 in the interval between the plurality of elastic members 120, and may clamp the band part 110 so that the band part 110 surrounds and seals the plurality of elastic members 120, the waterproof material 2, and the plurality of wires 3. The clamping part 130 may be connected to the band part 110. The clamping part 130 may be formed integrally with the band part 110. As illustrated in FIG. 5, the clamping part 130 is formed in an approximately hexahedral shape. Accordingly, unlike the band part 110, the clamping part 130 does not have flexible properties due to the nature of its shape.

The clamping part 130 may be a part that is combined with the band part 110. To this end, an insertion hole 131 into which the band part 110 is inserted may be formed in the clamping part 130. The insertion hole 131 may be formed to penetrate the clamping part 130 on both sides thereof, and may have an entrance that has an approximately rectangular shape and that corresponds to a shape of the band part 110.

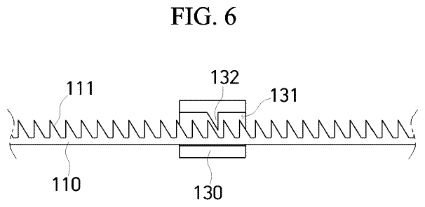

A process of the clamping part 130 of the wire sealing apparatus 100 according to embodiments of the present disclosure clamping the band part 110 is described below with reference to FIG. 6.

FIG. 6 is a cross-sectional view illustrating a form in which the clamping part of the wire sealing apparatus according to embodiments of the present disclosure clamps the band part.

Referring to FIG. 6, a plurality of trapping jaws 111 may be formed on one surface of the band part 110. The trapping jaw 111 is a part that is trapped at a fixing jaw 132 of the clamping part 130. The plurality of trapping jaws 111 may be consecutively formed on one surface of the band part 110.

The fixing jaw 132 may be provided within the insertion hole 131 of the clamping part 130. The fixing jaw 132 may correspond to the trapping jaw 111 of the band part 110. As the trapping jaw 111 is trapped at the fixing jaw 132, the fixing jaw 132 can serve to prevent the band part 110 from being separated in a direction opposite to the direction in which the band part 110 has been inserted. That is, after the band part 110 surrounds a task target, one end of the band part 110 passes through the insertion hole 131, and the trapping jaw 111 is trapped at the fixing jaw 132. Accordingly, the clamping part 130 clamps the band part 110.

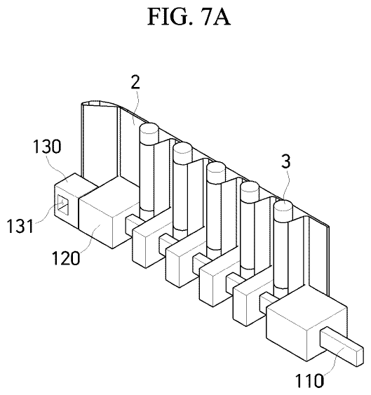

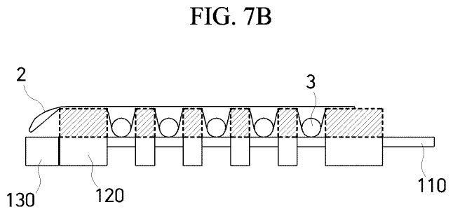

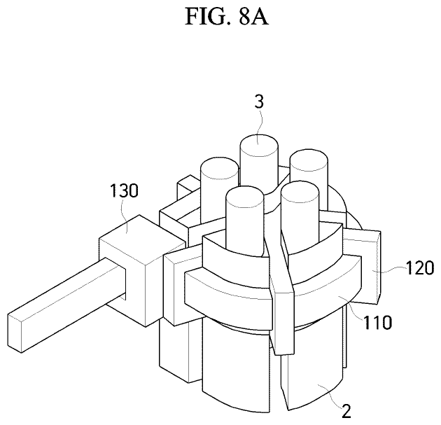

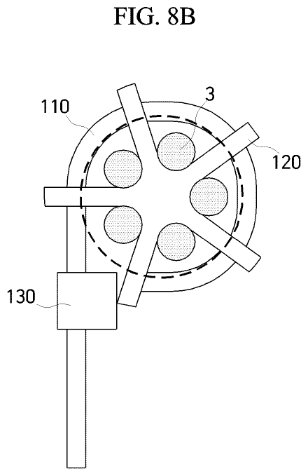

A process of the wire sealing apparatus 100 seating the plurality of wires 3 therein and clamping the band part 110 through the clamping part 130 is described below with reference to FIGS. 7A to 8B.

FIG. 7A is a perspective view illustrating a form in which the plurality of wires interposed in the waterproof material is seated in the wire sealing apparatus according to embodiments of the present disclosure. FIG. 7B is a cross-sectional view illustrating a form in which the plurality of wires interposed in the waterproof material has been seated in the wire sealing apparatus according to embodiments of the present disclosure.

Referring to FIG. 7A, the plurality of wires 3 interposed in the waterproof material 2 is seated in the interval between the plurality of elastic members 120 of the wire sealing apparatus 100 according to embodiments of the present disclosure. The size of the interval between the plurality of elastic members 120 may correspond to the size of the seated wires 3. As illustrated in FIG. 7B, each wire 3 may be seated in each interval between the plurality of elastic members 120.

FIG. 8A is a perspective view illustrating a form in which the clamping part of the wire sealing apparatus according to embodiments of the present disclosure has been clamped. FIG. 8B is a cross-sectional view illustrating a form in which the clamping part of the wire sealing apparatus according to embodiments of the present disclosure has been clamped.

Referring to FIGS. 8A and 8B, the clamping part 130 of the wire sealing apparatus 100, according to embodiments of the present disclosure, may seat the plurality of wires 3 interposed in the waterproof material 2 in the interval between the plurality of elastic members 120, and may clamp the band part 110 so that the band part 110 surrounds and seals the plurality of elastic members 120, the waterproof material 2, and the plurality of wires 3, as illustrated in FIG. 7B.

The elastic member 120 may closely adhere to and seal a curved surface of the wire due to its soft properties. The clamping part 130 may clamp the band part 110 by its strong clamping force so that the plurality of elastic members 120, the waterproof material 2, and the plurality of wires 3 can be sealed together. In embodiments, the elastic member 120 may be made of a material having a compression ratio of 50% to 90%. For example, the elastic member 120 may be high-density polyurethane foam or rubber.

In embodiments, the elastic member 120 may be selected from a material that satisfies an equation below (Equation 1).

$${A}_{T} - {W}_{T} = {E}_{T} \times C \qquad ( Equation 1 )$$

In the equation, A_{T} is an area within the band part 110 that surrounds and seals the plurality of elastic members 120, the waterproof material 2, and the plurality of wires 3. W_{T} is the sum of cross sections of the plurality of wires 3. E_{T} is the sum of areas of the plurality of elastic members 120 on the side of the wires 3 before sealing. C is a compression ratio of the elastic member 120.

In other words, A_{T} is an area including the plurality of elastic members 120, the waterproof material 2, and the plurality of wires 3 within the band part 110 after the clamping part 130 is clamped as illustrated as a dotted circle in FIG. 8B. W_{T} is the cross section of all of the plurality of wires 3 as illustrated as a dot pattern in FIG. 8B. E_{T} is the sum of areas on the side of the wires 3 before sealing, that is, before the plurality of elastic members 120 is compressed, as illustrated as oblique lines in FIG. 7B. C is the compression ratio of the elastic member 120. A numerical range of the compression ratio may be 50% to 90%.

According to embodiments of the present disclosure, the battery core pack 1 can be sealed without using resin, such as bonds, because the plurality of wires 3 is sealed by the elastic members 120.

According to embodiments of the present disclosure, the curved surface of the wire 3 may be filled by soft properties of the elastic member 120 and sealed through an external strong clamping force between the band part 110 and the clamping part 130, so that strong sealing power of the waterproof battery pack can be secured.

According to embodiments of the present disclosure, the elastic member 120 may be integrated with an escape structure corresponding to a cross-sectional shape of the wire 3, so that the battery core pack 1 can be sealed through a simple structure.

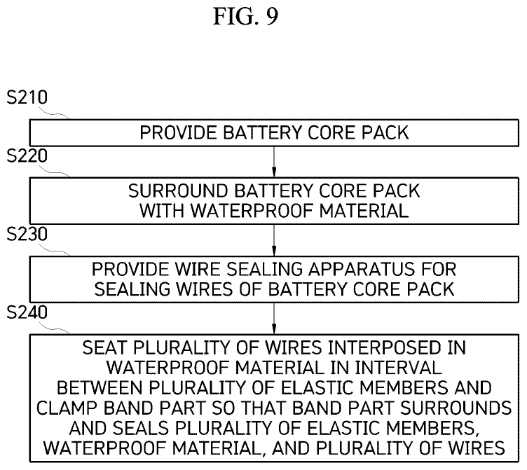

FIG. 9 is a flowchart for describing a method of manufacturing the waterproof battery pack according to embodiments of the present disclosure.

As illustrated in FIG. 9, the method of manufacturing the waterproof battery pack according to embodiments of the present disclosure may include steps S210 to S240.

Step S210 is a step of providing a battery core pack. In embodiments, the battery core pack may be provided or formed by packaging a plurality of cylindrical secondary batteries or a plurality of prismatic secondary batteries.

Step S220 is a step of surrounding the battery core pack with the waterproof material.

Step S230 is a step of providing the wire sealing apparatus that is a wire sealing apparatus for sealing the wires of the battery core pack and that may include the band part that extends in a length direction thereof, the plurality of elastic members that are provided at intervals of one or more elastic members in the length direction of the band part, and the clamping part that clamps the band part.

In embodiments, step S230 may include a step of forming the plurality of elastic members so that the size of the interval between the plurality of elastic members corresponds to the size of the seated wires.

In other embodiments, step S230 may include a step of forming the elastic member by using a material having a compression ratio of 50% to 90%.

In still other embodiments, step S230 may include a step of forming a plurality of trapping jaws on one surface of the band part and forming, in the clamping part, the fixing jaw that is trapped between the plurality of trapping jaws.

Step S240 may be a step of seating the plurality of wires interposed in the waterproof material in the interval between the plurality of elastic members and clamping the band part so that the band part surrounds and seals the plurality of elastic members, the waterproof material, and the plurality of wires.

As described above, the method of manufacturing the waterproof battery pack according to embodiments of the present disclosure has been described with reference to the flowcharts presented in the drawings. For a simple description, the method has been illustrated and described as a series of blocks, but the present disclosure is not limited to the sequence of the blocks, and some blocks may be performed in a sequence different from or simultaneously with that of other blocks, which has been illustrated and described in this specification. Various other branches, flow paths, and sequences of blocks which achieve the same or similar results may be implemented. Furthermore, all the blocks illustrated in order to implement the method described in this specification may not be required.

In the description given with reference to FIG. 9, each of the steps may be further divided into additional steps or the steps may be combined into smaller steps depending on an implementation example of the present disclosure.

Furthermore, some of the steps may be omitted, if necessary, and the sequence of the steps may be changed. Furthermore, the contents of FIGS. 1A to 8, although some contents are omitted therefrom, may be applied to the contents of FIG. 9. Furthermore, the contents of FIG. 9 may be applied to the contents of FIGS. 1A to 8.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}XbO_{2-c}D_{c} (0.90≤a≤1.8, 0≤b≤0.5, 0≤c≤0.05); LiₐMn_{2-b}XbO_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0≤α≤2); LiₐNi_{1-b-c}Mn_{b}X_{c}O_{2-α}D_{α}(0.90≤a≤1.8, 0≤b≤0.5, 0≤c≤0.5, 0≤α≤2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g 0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure may not be limited thereto.

A negative electrode active material may include a material capable of reversible intercalation/de-intercalation with respect to lithium ions, lithium metal, an alloy of lithium metal, a material capable of doping and dedoping with respect to lithium, or transition metal oxide.

The material capable of reversibly intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example, the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked

Although the present disclosure has been described above in connection with the exemplary embodiments and drawings, the present disclosure is not limited to the embodiments. A person having ordinary knowledge in the art to which the present disclosure pertains may modify and change the present disclosure within the technical spirit of the present disclosure.

What is claimed is:

1. A wire sealing apparatus for surrounding a battery core pack with a waterproof material and sealing wires of the battery core pack, the wire sealing apparatus comprising:
a band part that extends in a length direction thereof;
a plurality of elastic members provided at intervals of one or more elastic members in the length direction of the band part; and
a clamping part configured to seat a plurality of wires interposed in a waterproof material in an interval between the plurality of elastic members and to clamp the band part so that the band part surrounds and seals the plurality of elastic members, the waterproof material, and the plurality of wires.

2. The wire sealing apparatus as claimed in claim 1, wherein a size of the interval between the plurality of elastic members corresponds to a size of the seated wires.

3. The wire sealing apparatus as claimed in claim 1, wherein the elastic member is made of a material having a compression ratio of 50% to 90%.

4. The wire sealing apparatus as claimed in claim 1, wherein the elastic member is high-density polyurethane foam or rubber.

5. The wire sealing apparatus as claimed in claim 1, wherein the elastic member is selected from a material that satisfies the following equation:
$${A}_{T} - {W}_{T} = {E}_{T} \times C$$
wherein A_{T} is an area within the band part that surrounds and seals the plurality of elastic members, the waterproof material, and the plurality of wires, W_{T} is a sum of cross sections of the plurality of wires, E_{T} is a sum of areas of the plurality of elastic members on a wire side before sealing, and C is a compression ratio of the elastic member.

6. The wire sealing apparatus as claimed in claim 1, wherein a plurality of trapping jaws is formed on one surface of the band part.

7. The wire sealing apparatus as claimed in claim 6, wherein:
an insertion hole into which the band part is inserted is formed in the clamping part through the clamping part, and
a fixing jaw that is trapped between the plurality of trapping jaws is formed in the insertion hole.

8. A waterproof battery pack comprising:
a battery core pack;
a waterproof material that surrounds the battery core pack; and
a wire sealing apparatus for sealing a plurality of wires of the battery core pack,
wherein the wire sealing apparatus comprises a band part that extends in a length direction thereof, a plurality of elastic members provided at intervals of one or more elastic members in the length direction of the band part, and a clamping part configured to seat the plurality of wires interposed in the waterproof material in an interval between the plurality of elastic members and to clamp the band part so that the band part surrounds and seals the plurality of elastic members, the waterproof material, and the plurality of wires.

9. The waterproof battery pack as claimed in claim 8, wherein a size of the interval between the plurality of elastic members corresponds to a size of the seated wires.

10. The waterproof battery pack as claimed in claim 8, wherein the elastic member is made of a material having a compression ratio of 50% to 90%.

11. The waterproof battery pack as claimed in claim 8, wherein the elastic member is high-density polyurethane foam or rubber.

12. The waterproof battery pack as claimed in claim 8, wherein the elastic member is selected from a material that satisfies the following equation:
$${A}_{T} - {W}_{T} = {E}_{T} \times C$$
wherein A_{T} is an area within the band part that surrounds and seals the plurality of elastic members, the waterproof material, and the plurality of wires, W_{T} is a sum of cross sections of the plurality of wires, E_{T} is a sum of areas of the plurality of elastic members on a wire side before sealing, and C is a compression ratio of the elastic member.

13. The waterproof battery pack as claimed in claim 8, wherein a plurality of trapping jaws is formed on one surface of the band part.

14. The waterproof battery pack as claimed in claim 13, wherein:
an insertion hole into which the band part is inserted is formed in the clamping part through the clamping part, and
a fixing jaw that is trapped between the plurality of trapping jaws is formed in the insertion hole.

15. A method of manufacturing a waterproof battery pack, the method comprising:
providing a battery core pack;
surrounding the battery core pack with a waterproof material;
providing a wire sealing apparatus that is a wire sealing apparatus for sealing a plurality of wires of the battery core pack and that comprises a band part that extends in a length direction thereof, a plurality of elastic members that are provided at intervals of one or more elastic members in the length direction of the band part, and a clamping part that clamps the band part; and
seating the plurality of wires interposed in the waterproof material in an interval between the plurality of elastic members and clamping the band part so that the band part surrounds and seals the plurality of elastic members, the waterproof material, and the plurality of wires.

16. The method as claimed in claim 15, wherein the providing of the wire sealing apparatus comprises forming the plurality of elastic members so that a size of the interval between the plurality of elastic members corresponds to a size of the seated wires.

17. The method as claimed in claim 15, wherein the providing of the wire sealing apparatus comprises forming the elastic member having a material having a compression ratio of 50% to 90%.

18. The method as claimed in claim 15, wherein the providing of the wire sealing apparatus comprises selecting the elastic member from a material that satisfies the following equation:
$${A}_{T} - {W}_{T} = {E}_{T} \times C$$
wherein A_{T} is an area within the band part that surrounds and seals the plurality of elastic members, the waterproof material, and the plurality of wires, W_{T} is a sum of cross sections of the plurality of wires, E_{T} is a sum of areas of the plurality of elastic members on a wire side before sealing, and C is a compression ratio of the elastic member.

19. The method as claimed in claim 15, wherein the providing of the wire sealing apparatus comprises forming a plurality of trapping jaws on one surface of the band part.

20. The method as claimed in claim 19, wherein the providing of the wire sealing apparatus further comprises forming, in the clamping part, a fixing jaw that is trapped between the plurality of trapping jaws.
